(19) United States
(12) Patent Application Publication
(10) Pub. No.: US 2026/0226295 A1
(43) Pub. Date: Aug. 6, 2026

(54) COATING COMPOSITION

(71) Applicant: Rohm and Haas Company, Collegeville, PA (US)

(72) Inventors: Kimy Yeung, Phoenixville, PA (US); Jeffrey J. Sobczak J. Sobczak, Collegeville, PA (US)

(21) Appl. No.: 19/137,056

(22) PCT Filed: Nov. 30, 2023
(86) PCT No.: PCT/US2023/081720

§ 371 Date: Jun. 9, 2025

Related U.S. Application Data
(60) Provisional application No. 63/432,512, filed on Dec. 14, 2022.

(51) Int. Cl. C09D 7/63; C08K 3/22; C08K 3/38; C08K 5/5419; C09D 5/02; C09D 5/16; C09D 7/43; C09D 7/61; C09D 133/04

(52) U.S. Cl. CPC C09D 7/63; C08K 3/38; C08K 5/5419; C09D 5/028; C09D 5/1687; C09D 7/43; C09D 7/61; C09D 133/04; C08K 2003/2241

(57) ABSTRACT

Dirt pickup resistance and/or color retention of an exterior insulation and finish system (EIFS) with a finish layer having high PVC of inorganic filler and/or pigment can be improved by adding an alkali metal siliconate to the finish layer in an amount effective to improve dirt pickup resistance and/or color retention.

### FIELD

This application relates to the field of coating compositions.

### BACKGROUND

Exterior insulation and finish systems (EIFS) are used on the outside of buildings to provide good thermal insulation, weatherability and appearance at a low price. EIFS comprise at least three layers:
1. A layer of insulation, which is typically foam insulation board such as STYROFOAM™ insulation, adhered directly or indirectly to a wall substrate by adhesive or mechanical fasteners;
2. A layer of base coat adhered directly or indirectly to the insulation layer, which comprises a fiber mesh embedded in a coating material; and
3. A layer of finish coat adhered directly or indirectly to the base coat, which comprises a coating material that provides weatherability and the desired appearance.

Other layers may also be included, such as a water channel under the insulation layer to let water escape if it gets under the EIFS or a waterproof layer to protect the substrate from water that gets under the EIFS. EIFS and layers found in them are described in many public references such as US Patent Publications 2014/0373474 and 2015/0159008 and “Application Fast Facts: EIFS”, Publication 832-00189-01 published by The Dow Chemical Company and available at dow.com/en-us/market/mkt-building-construction/sub-build-wall-systems-insulation-facade.html.

The finish coat generally contains inorganic filler, an organic binder and additives. The filler typically includes sand and other inorganic particulates; it may include some materials that are classified as inorganic pigments, such as titanium dioxide. The binder is frequently an emulsion polymer, such as an acrylic polymer. In many cases, the finish layer is designed to have high solar reflectance, in order to minimize solar heating of the underlying building and reduce energy and cost needed to keep the building cool. In these cases, the fillers may contain a high content of white ingredients, such as titanium dioxide and calcium carbonate. Other additives may include known additives for exterior coatings such as organic pigments, thickeners and flow modifiers, surfactants, antioxidants and stabilizers.

The finish coat is frequently applied as an aqueous slurry. The slurry generally has high viscosity, so that the finish coat can be applied with a trowel at a thickness 0.1 cm to 2.5 cm on a vertical application. The external appearance is often similar to stucco, so that EIFS surfaces are sometimes referred to as “synthetic stucco.”

EIFS are continually exposed to sun and weather. Dirt pickup is a concern for EIFS, especially with light-colored EIFS and EIFS that contain high levels of filler. Light colors show dirt more than dark colors, and dirt pickup can reduce the solar reflectance of light-colored EIFS used in cool-building designs. Further, EIFS that contain high levels of filler are especially susceptible to accumulation of dirt. Some aromatic compounds are known to improve dirt pickup resistance, such as benzophenone and methyl-2-benzoyl benzoate, but they increase the volatile organic content of the finish coat.

Color retention is also a concern for EIFS. Organic colorants are prone to degradation upon exposure to sun and weather.

What is needed is a finish coat formulation for an EIFS that has improved color retention and/or dirt pickup resistance.

### SUMMARY

We have discovered that a small amount of alkali metal siliconate in a finish coating can enhance dirt pickup resistance and/or color retention. The effect is especially strong in coatings that contain high levels of filler.

A first aspect of the invention is an aqueous coating composition comprising:
a) From 70 to 90 pigment volume concentration (PVC) of inorganic filler;
b) An acrylic polymer binder in a concentration effective to bind the filler and other components of the finish coat to a substrate;
c) An alkali metal siliconate in a concentration that is effective to increase the dirt pickup resistance or color retention of the resulting coating; and
d) Water in a quantity sufficient to fully wet the dry ingredients and provide a slurry.

A second aspect of the invention is a process to coat a substrate comprising the steps of (1) applying an aqueous coating composition to the substrate and (2) allowing the aqueous coating composition to dry and harden, wherein the aqueous coating composition is an aqueous coating composition from the first aspect of the invention. In some embodiments, the substrate comprises the insulation layer and the base coat of an exterior insulation and finish system, and the aqueous coating composition is applied as a finish coat.

A third aspect of the invention is an exterior insulation and finish system attached to an exterior surface of a structure comprising:
a) A layer of insulation that comprises a foamed polymer insulation and is adhered directly or indirectly to a substrate that forms the exterior surface of the structure;
b) A base coat that comprises a fiber mesh embedded in a coating material and is adhered directly or indirectly to the insulation layer; and
c) A finish coat that is adhered directly or indirectly to the base coat and comprises:
   i) From 70 to 90 pigment volume concentration (PVC) of inorganic filler;
   ii) An acrylic polymer binder in a concentration effective to bind the filler and other components of the finish coat to a substrate; and
   iii) An alkali metal siliconate and/or its reaction products in a concentration that is effective to increase the dirt pickup resistance or color retention of the coating.

### DETAILED DESCRIPTION

Aqueous coating compositions of the present invention and the resulting coatings contain conventional ingredients for finish coats in EIFS: inorganic filler, an organic binder, water and optionally additives. Aqueous coating compositions of the present invention also comprise alkali metal siliconate, and the content of inorganic filler and/or pigment is relatively high for finish coats. Higher levels of inorganic filler and/or pigment conventionally increase dirt pickup and reduce color retention, but in the present invention dirt pickup and color retention can be improved by the alkali metal siliconate and/or its reaction products.

### Filler

The inorganic fillers used in the aqueous coating composition are powders and granules that are insoluble in water.

In some embodiments, the inorganic fillers include oxides, carbonates and sulfates of silicon, calcium, titanium and/or aluminum. Examples of common inorganic fillers include silica, titanium dioxide, calcium carbonate, dolomite, kaolin, barium sulfate, wollastonite, mica, talc, feldspar and glass particles.

In some embodiments, the filler may include materials that are classified as inorganic pigments or pigment extenders. Examples of light colored inorganic pigments and pigment extenders that may be included in the filler include titanium dioxide, antimony white, titanium white, zinc white or barium sulfate, chrome yellow, cobalt yellow and titanium yellow. The filler may also comprise dark colored inorganic pigments, such as iron and copper oxides and carbon black, but use of dark or colored inorganic fillers and pigments may reduce the importance of dirt pickup resistance and color retention.

It is known in the EIFS art to select fillers that have a particle size suitable for the aqueous coating composition. Some examples of coarse fillers may have a particle size of at least 100 μm or at least 200 μm or at least 300 μm or at least 500 μm and may have a particle size of at most 3 mm or at most 2 mm or at most 1.5 mm or at most 1 mm or at most 800 μm or at most 600 μm. Some examples of fine fillers and pigment extenders may have smaller particle sizes, such as at least 1 μm and at most 100 μm.

The inorganic fillers are typically insoluble in water. Dispersing and wetting agents may help to maintain a stable slurry or dispersion. Suitable dispersing and wetting agents are known and commercially available, such as under the following trademarks: TAMOL™, Calgon, and Dispex. In some embodiments, the dispersant may be a polycarboxylate, a polyphosphate or a block copolymer having blocks that interact with water and blocks that interact with the filler/pigment. In some embodiments, a wetting agent is a surfactant such as a salt of a fatty acid, a poly(ethylene oxide) surfactant or a silicone-based surfactant.

The quantity of fillers in coatings formulations can be described using pigment volume concentration (“PVC”), which is the volume of pigment and filler as a percent of the total volume of solid components in the coating formulation. PVC is calculated by Formula 1:

$$PVC = \frac{{V}_{\text{?}} \text{?} {V}_{\text{?}}}{{V}_{\text{?}} \text{?} {V}_{\text{?}} \text{?} {V}_{\text{?}}} \times 100 \qquad ( 1 )$$

$$\text{?} \text{indicates text missing or illegible when filed}$$

wherein Vₚ is the dry volume of pigment, Vₑ is the dry volume of filler and V_{b} dry is the dry volume of binder.

Aqueous coating compositions of the present invention have 70 to 90 PVC. In some embodiments, the aqueous coating composition contains at least 73 PVC, or at least 75 PVC or at least 77 PVC or at least 79 PVC or 80 PVC. In some embodiments, the aqueous coating composition contains at most 88 PVC, or at most 86 PVC or at most 84 PVC or at most 82 PVC. On the one hand, it may be observed that coatings with higher PVC are more susceptible to dirt pickup, and so in some embodiments aqueous coating compositions in the lower PVC range may be preferred. On the other hand, some embodiments of the inventive formulations are particularly effective in reducing dirt pickup of high PVC coatings, so in some embodiments it may be desirable to use the invention with aqueous coating compositions that are high in the PVC range.

The quantity of filler may also be described in terms of weight percent. In some embodiments, the aqueous coating composition contains at least 70 weight percent filler, based on the weight of dry ingredients excluding water, or at least 75 weight percent or at least 80 weight percent or at least 83 weight percent or at least 85 weight percent or at least 86 weight percent or at least 87 weight percent. (The “dry ingredients” are the inorganic filler, the acrylic polymer binder, the alkali metal siliconate and any other solid additives to the aqueous coating composition.) In some embodiments, the aqueous coating composition contains at most 94 weight percent filler, based on the weight of dry ingredients excluding water, or at most 93 weight percent or at most 92 weight percent or at most 91 weight percent or at most 90 weight percent. For example, the aqueous coating composition may contain from 80 to 93 weight percent filler, based on dry ingredients excluding water, or from 85 to 92 weight percent or from 87 to 90 weight percent.

In some embodiments, the aqueous coating composition contains at least 65 weight percent filler, based on all ingredients including water, or at least 70 weight percent or at least 72 weight percent or at least 74 weight percent or at least 76 weight percent. In some embodiments, the aqueous coating composition contains at most 90 weight percent filler, based on all ingredients including water, or most 88 weight percent or at most 86 weight percent or at most 84 weight percent or at most 82 weight percent or at most 80 weight percent. For example, the aqueous coating composition may contain from 70 to 90 weight percent filler, based on all ingredients including water, or from 72 to 84 weight percent or from 74 to 82 weight percent.

### Binder

The aqueous coating composition of the present invention comprises an acrylic polymer binder in a concentration effective to bind the filler and other components of the aqueous coating composition to a substrate. Acrylic polymer binders and aqueous dispersions that contain acrylic polymer binders are known, and they are commercially available. They are described in publications such as “Paints” published by Department of Chemistry, University of York at https://www.essentialchemicalindustry.org/materials-and-applications/paints.html (Mar. 18, 2013).

An acrylic polymer is a polymer or copolymer that contains repeating units derived from acrylic monomers. Acrylic monomers include acrylic acid, methacrylic acid, and their esters. Exemplary esters used in acrylic monomers include alkyl esters, such as alkyl groups containing from 1 to 8 carbon atoms or from 1 to 4 carbon atoms or in some cases methyl groups or ethyl groups. Examples of useful acrylic monomers are acrylic acid, methacrylic acid, butyl acrylate, 2-ethylhexyl acrylate, methyl acrylate, ethyl acrylate, methyl methacrylate and ethyl methacrylate.

Exemplary acrylic polymer binders may contain at least 70 weight percent repeating units derived from acrylic monomers, or at least 80 weight percent or at least 90 weight percent or at least 95 weight percent. Exemplary acrylic polymer binders may contain up to 100 percent repeating units derived from acrylic monomers. Some exemplary acrylic polymer binders are copolymers containing units derived from two or more acrylic monomers, such as copolymers of butyl acrylate with methyl methacrylate and/or methacrylic acid.

Some exemplary acrylic polymer binders may contain a crosslinking acrylic monomer, such as acetoacetoxyethyl methacrylate (AAEM), which is sold under the trademark: Eastman AAEM. The crosslinking monomer enables the acrylic polymer binder to crosslink as it sets when applied as a coating. In some embodiments, no more than 10 mole percent of repeating units in the acrylic polymer binder are derived from crosslinking acrylic monomers or no more than 5 mole percent or no more than 3 mole percent or no more than 2 mole percent or no more than 1 mole percent. In some embodiments, 0 mole percent of repeating units in the acrylic polymer binder are derived from crosslinking acrylic monomers or at least 0.1 mole percent or at least 0.5 mole percent or at least 1 mole percent. An example of a suitable acrylic polymer binder containing a crosslinking acrylic monomer is sold as RHOPLEX™ VSR 1065.

Some exemplary acrylic polymer binders may contain repeating units derived from non-acrylic ethylenically unsaturated comonomers, such as ethylene, vinyl esters (such as vinyl acetate) or styrene. Aryl groups can make the acrylic polymer susceptible to degradation by ultraviolet light. In some embodiments, monomers that contain aryl groups, such as styrene and phenyl esters of acrylic and methacrylic acid, are minimized. In some embodiments, less than 50 mole percent of monomers in the acrylic polymer contain aryl groups, or less than 30 mole percent or less than 20 mole percent or less than 10 mole percent or less than 5 mole percent or less than 2 mole percent. In some embodiments, the acrylic polymer contains no detectable level of aryl-containing monomers, which is essentially 0 percent.

On the other hand, styrene monomer can provide other useful qualities to the acrylic polymer binder, such as increased hydrophobicity. In some embodiments, the acrylic polymer binder is a styrene-acrylic copolymer, such as UCAR™ DL 424.

The selection of acrylic monomers and their proportions are governed by the intended use of the acrylic polymer as a binder in an exterior coating. The coating may be subjected to thermal expansion and contraction due to changes in outdoor temperature. The acrylic polymer binder may be selected to have a low Tg, such as at most 0° C. or −10° C. or −15° C. or −20° C. or −30° C. or −40° C. There is no minimum desirable Tg, but Tg below −60° C. are seldom necessary.

The acrylic polymer binder may also need to remain non-molten in temperatures that exterior coatings are commonly exposed to. In some embodiments, the acrylic polymer binder has a melting temperature of at least 60° C. or at least 75° C. or at least 80° C. or at least 95° C. or at least 110° C. There is no maximum desirable melting temperature, but temperatures above 200° C. are seldom necessary.

Increasing content of certain monomers, such as methyl methacrylate, is known to increase Tg and melting point of the resulting polymer, and increasing content of other monomers, such as butyl acrylate, is known to reduce Tg and melting point of the resulting polymer. In some embodiments, the acrylic polymer binder contains at least 7 weight percent units derived from methyl methacrylate or at least 10 weight percent or at least 12 weight percent. In some embodiments, the acrylic polymer binder contains at most 50 weight percent units derived from methyl methacrylate or at most 45 weight percent or at most 40 weight percent. In some embodiments, the acrylic polymer binder contains at least 50 weight percent units derived from butyl acrylate or at least 55 weight percent or at least 60 weight percent. In some embodiments, the acrylic polymer binder contains at most 93 weight percent units derived from butyl acrylate or at most 90 weight percent or at most 88 weight percent.

In some embodiments, the particles of acrylic polymer binder have an average diameter of at least 50 nm or at least 100 nm or at least 200 nm. In some embodiments, the particles of acrylic polymer binder have an average diameter of at most 700 nm or at most 500 nm or at most 400 nm.

Binders are often film-forming under the conditions at which they are applied to the intended substrate. “Film-forming” means that a substance is capable of forming a film upon application to a solid surface. The ability of polymers and their emulsions to be film-forming is known and described in publications such as: P. A. Steward et al., “An Overview of Polymer Latex Film Formation and Properties”, 86 Advances in Colloid and Interface Science at 195-267 (2000). Commonly, the film-forming ability of polymers increases with lower molecular weight and/or lower Tg and decreases with higher molecular weight and/or higher Tg.

In the aqueous coating composition, the binder particles are suspended in an aqueous emulsion. This is often accomplished using emulsifiers, which are usually surfactants. In some embodiments, the emulsifiers are anionic surfactants, and in some embodiments the emulsifiers are non-ionic surfactants. Examples of suitable emulsifiers are sodium dodecylbenzenesulfonate and sodium lauryl sulfate. Examples of suitable emulsifiers are available under the DOWFAX™, TRITON™, TERGITOL™, ECOSURF™, and Polystep trademarks.

Suitable acrylic polymer binders are commercially available from the Dow Chemical Company under the RHOPLEX™, PRIMAL™, and UCAR™ trademarks. Other acrylic polymer binders can be made by emulsion polymerization of suitable monomers in the presence of suitable emulsifiers. Emulsion polymerization processes are well-known and described in numerous publications, such as Emulsion Polymerization of Acrylic Monomers, published by Rohm and Haas Company (1966) and is available at https://is 600709.us.archive.org/24/items/emulsionpolymeri00rohm/emulsionpolymeri00rohm.pdf; Lovell et al, Fundamentals of Emulsion Polymerization, 21 Biomacromolecules 4396-4441 (2020); and Juaregui, Thesis: Synthesis and Optimization of Emulsion Polymers published by California Polytechnic State University, San Luis Obispo (2016).

Aqueous coating compositions of the present invention contain high pigment volume concentration, so they necessarily contain low levels of binder, but the binder concentration must be high enough to effectively adhere the dry components of the aqueous coating composition to the substrate when the aqueous coating composition is set. In some embodiments, the aqueous coating composition contains at least 8 volume percent binder or at least 10 volume percent or at least 12 volume percent or at least 14 volume percent or at least 16 volume percent or at least 18 volume percent, based on dry ingredients only and excluding water. In some embodiment, the aqueous coating composition contains at most 30 volume percent binder or at most 27 volume percent or at most 25 volume percent or at most 23 volume percent or at most 21 volume percent, based on dry ingredients only and excluding water.

In some embodiments, the aqueous coating composition contains at least 4 weight percent binder, based on dry ingredients excluding water, or at least 5 weight percent or at least 6 weight percent or at least 7 weight percent or at least 8 weight percent. In some embodiments, the aqueous coating composition contains at most 18 weight percent binder, based on dry ingredients excluding water, or at most 15 weight percent or at most 12 weight percent or at most 10 weight percent. For example, the aqueous coating composition may contain from 5 to 18 weight percent binder, based on dry ingredients excluding water, or from 6 to 15 weight percent or from 7 to 10 weight percent.

In some embodiments, the aqueous coating composition contains at least 4 weight percent binder, based on all ingredients including water, or at least 5 weight percent or at least 6 weight percent or at least 7 weight percent. In some embodiments, the aqueous coating composition contains at most 15 weight percent binder, based on all ingredients including water, or at most 12 weight percent or at most 10 weight percent or at most 9 weight percent. For example, the aqueous coating composition may contain from 4 to 15 weight percent binder, based on all ingredients including water, or from 5 to 12 weight percent or from 6 to 9 weight percent.

In some embodiments, the acrylic polymer binder is added to the aqueous coating composition as an aqueous emulsion. In some embodiments, the aqueous emulsion contains at least 30 weight percent acrylic polymer binder or at least 40 weight percent and at most 70 weight percent acrylic polymer binder or at most 60 weight percent or at most 50 weight percent. In some embodiments, the aqueous emulsion contains at least 30 weight percent water or at least 40 weight percent or at least 50 weight percent and at most 70 weight percent water or at most 60 weight percent. Weight and volume percentages listed above refer to the weight of the acrylic polymer binder and not to the weight of water in the emulsion that contains the acrylic polymer binder.

### Alkali Metal Siliconate

The aqueous coating composition contains an alkali metal siliconate, in a concentration that is effective to increase the dirt pickup resistance or the color retention of the resulting coating. Alkali metal siliconates generally correspond to Formula 2:

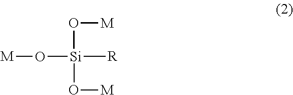

wherein each M is independently hydrogen or an alkali metal selected such that at least one M is an alkali metal, and R is an organic moiety.

In some embodiments, one M is an alkali metal, in some embodiments two M are an alkali metal, and in some embodiments all three M are an alkali metal. In some embodiments, the alkali meat siliconate contains a mixture of species containing different numbers of metal ions. In some embodiments, the mixture of species contains on average at least 1.0 alkali metal ions per molecule or at least 1.5 alkali metal ions or at least 2.0 alkali metal ions or at least 2.5 alkali metal ions. In some embodiments, the mixture of species contains on average at most 3.0 alkali metal ions per molecule or at most 2.5 alkali metal ions or at most 2.0 alkali metal ions or at most 1.5 alkali metal ions or at most 1.25 alkali metal ions or at most 1.0 alkali metal ion.

In some embodiments, the alkali metal is lithium. In some embodiments, the alkali metal is sodium. In some embodiments, the alkali metal is potassium. In some embodiments, the alkali metal siliconate contains a mixture of different alkali metals.

In some embodiments, the organic moiety R contains no more than 12 carbon atoms, or no more than 8 carbon atoms or no more than 6 carbon atoms or no more than 4 carbon atoms. In some embodiments, the organic moiety R contains just 1 carbon atom.

In some embodiments, the organic moiety R is substituted or unsubstituted aliphatic, and in some embodiments, it is substituted or unsubstituted alkyl. In some embodiments, the organic moiety R is unsubstituted. In some embodiments, the organic moiety R contains an alcohol, acid, or halide substituent.

In some embodiments, the organic moiety R is an unsubstituted methyl, ethyl, propyl, or butyl group.

Common alkali metal siliconates that are commercially available include sodium methyl siliconate and potassium methyl siliconate. An aqueous solution containing potassium methyl siliconate (40 weight percent concentration) is commercially available from The Dow Chemical Company under the trademark XIAMETER™ OFS-0777. An aqueous solution containing sodium methyl siliconate (40 weight percent concentration) is commercially available from The Dow Chemical Company under the trademark XIAMETER™ OFS-0772. Other siliconates can be made by known processes, such as by contacting a trichloro organosilane with water and alkali metal hydroxide. U.S. Pat. No. 4,252,569 describes a process to make alkali metal siliconate, and also lists many other patents that describe processes to make alkali metal siliconate.

The concentration of alkali metal siliconate in the aqueous coating composition is effective to increase the dirt pickup resistance or color retention of the resulting coating. In some embodiments, the aqueous coating composition contains at least 0.20 weight percent alkali metal siliconate, based on the dry components and excluding water, or at least 0.30 weight percent or at least 0.35 weight percent or at least 0.40 weight percent or at least 0.42 weight percent or at least 0.44 weight percent. In some embodiments, the aqueous coating composition contains at most 3.5 weight percent alkali metal siliconate, based on the dry components and excluding water, or at most 3 weight percent or at most 2 weight percent or at most 1.5 weight percent or at most 1.0 weight percent or at most 0.9 weight percent or at most 0.8 weight percent or at most 0.7 weight percent or at most 0.6 weight percent or at most 0.5 weight percent. For example, the concentration of the alkali metal siliconate in the aqueous coating composition, based on the dry components and excluding water, may be from 0.2 to 3.5 weight percent or from 0.3 to 2 weight percent or from 0.3 to 1 weight percent or from 0.4 to 0.8 weight percent or 0.4 to 0.6 weight percent.

In some embodiments, the aqueous coating composition contains at least 0.10 weight percent alkali metal siliconate, based on all components including water, or at least 0.20 weight percent or at least 0.25 weight percent or at least 0.30 weight percent or at least 0.35 weight percent or at least 0.38 weight percent or at least 0.40 weight percent. In some embodiments, the aqueous coating composition contains at most 3 weight percent alkali metal siliconate, based on all components including water, or at most 2 weight percent or at most 1.5 weight percent or at most 1.0 weight percent or at most 0.9 weight percent or at most 0.8 weight percent or at most 0.7 weight percent or at most 0.6 weight percent or at most 0.5 weight percent. For example, the concentration of the alkali metal siliconate in the aqueous coating composition, based on all components including water, may be from 0.1 to 3 weight percent or from 0.2 to 2 weight percent or from 0.3 to 1 weight percent or from 0.35 to 0.8 weight percent or 0.35 to 0.6 weight percent.

In some embodiments, the weight ratio of alkali metal siliconate to acrylic polymer binder in the aqueous coating composition is at least 5 weight percent or at least 8 weight percent or at least 10 weight percent or at least 12 weight percent or at least 15 weight percent or at least 18 weight percent or at least 20 weight percent. In some embodiments, the weight ratio of alkali metal siliconate to acrylic polymer binder in the aqueous coating composition is at most 50 weight percent or at most 40 weight percent or at most 35 weight percent or at most 30 weight percent or at most 25 weight percent.

Alkali metal siliconates are known to react with carbon dioxide to form silicone polymers and/or oligomers. Without intending to bound, we hypothesize that at least some of the alkali metal siliconate may react after the aqueous coating composition is applied, so that the set coating may contain less or no alkali metal siliconate but may contain reaction products of the alkali metal siliconate. Examples of reaction products may include silicone polymers and oligomers having the organic substituents derived from the alkali metal siliconate. In some embodiments, the combined content of alkali metal siliconate and reaction products in the set coating is within the concentration limits set out for the alkali metal siliconate in the aqueous coating composition.

### Other Additives

The aqueous coating composition may optionally contain other additives that are appropriate for finish coatings in EIFS, other than the filler, binder, alkali metal siliconate and water. Commercial embodiments of EIFS finish coatings typically contain multiple additives. Many such components are described in the publication Johan Bieleman (ed.), Additives for Coatings, published by WILEY-VCH Verlag GmbH (2000). Some examples of common additives are listed below. All of the additives listed below are commercially available with recommendations for their use.

The aqueous coating composition may optionally contain organic dyes and pigments in a quantity effective to color the resulting coating. Examples of suitable organic dyes and pigments include phthalocyanines (blue/green), quinacridones (red/yellow), quinone derivatives, and azo compounds. Aqueous coating compositions of this invention may be especially useful with organic dyes and pigments because they can offer improved color retention.

The aqueous coating composition may optionally contain thickeners to make it easier to handle and apply. Examples of thickeners include inorganic materials, such as certain clays, and polymer thickeners, such as cellulose ethers, starches, and acrylic polymers.

The aqueous coating composition may optionally contain surfactants for a number of purposes. Some surfactants are emulsifiers, wetting agents, and dispersants, which help insoluble components to enter and remain in an emulsion or dispersion in the aqueous solvent. Some surfactants are antifoaming agents. Some surfactants can promote adhesion of the aqueous coating composition to a substrate.

The aqueous coating composition may optionally contain hydrophobic additives to improve the ability of the resulting coating to resist water infiltration. Examples of hydrophobic components may include waxes and polymers, such as polypropylene, as well as silicones, silanes, or siloxane components.

The aqueous coating composition may optionally contain levelling and coalescing agents. Examples of levelling additives include certain polyacrylate polymers, which have a low glass-transition temperature, such as −20° C. or lower. Coalescing agents promote interaction of binder molecules as the coating dries on the substrate, to form a solid homogeneous film that does not redissolve when subjected to new water. Examples of coalescing agents include:
certain branched and cyclic paraffins,
certain esters such as 3-hydroxy-2,2,4-trimethylpentyl isobutyrate (TPiB), diesters of adipic acid (ADE), dimethyl phthalate (DMP), 2-hydroxypropyl ethylhexanoate (HPE), and benzyl benzoate, and
certain ether alcohols, such as ethylene glycol butyl ether, propylene glycol butyl ether, dipropylene glycol butyl ether (DPB), and propylene and ethylene glycol phenyl ether (PPH and EPH

The aqueous coating composition may optionally contain antioxidants. Antioxidants may include a primary antioxidant, such as certain amines or sterically hindered phenols and/or a secondary antioxidant, such as certain organophosphates or thioesters.

The aqueous coating composition may optionally contain light and ultraviolet (UV) stabilizers. Examples of light and ultraviolet light (UV) stabilizers may include:
UV absorbers such as benzotriazoles and other compounds having coordinated double bonds; and
Sterically hindered amines such as compounds containing a 2,2,6,6-tetramethylpiperidine group.

The aqueous coating composition may optionally contain other additives in addition to the alkali metal siliconate to further improve the dirt pickup resistance (DPUR) of the resulting coating. Examples of DPUR additives include some aromatic compounds, such as benzophenone and methyl-2-benzoyl benzoate, some fluorinated surfactants, some waxes, and some silicones, such as polydimethylsiloxane (PDMS).

In some embodiments, the quantity of additives (excluding the alkali metal siliconate) is no more than 8 weight percent of the aqueous coating composition, based on dry ingredients excluding water, or no more than 6 weight percent or no more than 5 weight percent or no more than 4 weight percent or no more than 3 weight percent. The quantity of additives (excluding the alkali metal siliconate) may be 0 weight percent, but in some embodiments, the quantity of other additives is at least 0.2 weight percent or at least 0.5 weight percent or at least 0.8 weight percent or at least 1 weight percent or at least 1.5 weight percent or at least 2 weight percent. In some embodiments, the quantity of additives (excluding the alkali metal siliconate) is low enough that volume percent, weight percent excluding water, and weight percent including water are roughly the same, so the concentrations previously described can also apply to volume percent and weight percent including water. For example, in some embodiments, the aqueous coating composition contains from 0.2 to 8 weight percent additives, based on the dry weight of ingredients and excluding water, or from 0.5 to 5 weight percent or from 1 to 3 weight percent. In some embodiments, the aqueous coating composition contains from 0.2 to 8 weight percent additives, based on all ingredients including water, or from 0.5 to 5 weight percent or from 1 to 3 weight percent.

### Water

The aqueous coating composition contains water. The amount of water is suitable to fully wet the dry ingredients and to form a slurry. In some embodiments, the slurry has a viscosity low enough that it can be applied smoothly and high enough that it can be applied to a vertical surface and dry without materially flowing down the surface. In some embodiments, the viscosity of the aqueous coating composition is at least 70 PU or at least 80 PU or at least 90 PU. In some embodiments, the viscosity is at most 120 PU or at most 130 PU or at most 140 PU.

In some embodiments, the aqueous coating composition contains at least 5 weight percent water or at least 8 weight percent or 9 weight percent or at least 10 weight percent. In some embodiments, the aqueous coating composition contains at most 25 weight percent water or at most 20 weight percent or most 18 weight percent or at most 16 weight percent. For example, in some embodiments, the aqueous coating composition contains from 5 to 25 weight percent water, or from 5 to 20 weight percent or from 8 to 18 weight percent or from 9 to 15 weight percent. Note that in some cases the acrylic polymer binder, the alkali metal siliconate, and/or other additives in the aqueous coating composition may be added as solutions, emulsions or suspensions that contain water; in this case, only a small amount of additional water may be needed to achieve desirable levels of water in the overall aqueous coating composition.

In some embodiments, the aqueous coating composition further contains an organic solvent that is miscible with water. Examples of suitable organic solvents include alcohols and glycols. In some embodiments, the quantity of organic solvent is no more than 8 weight percent of the aqueous coating composition, including water, or no more than 6 weight percent or no more than 5 weight percent or no more than 4 weight percent or no more than 3 weight percent. The quantity of organic solvents may be 0 weight percent, but in some embodiments, the quantity of organic solvent is at least 0.5 weight percent or at least 1 weight percent or at least 1.5 weight percent or at least 2 weight percent. In some embodiments, the quantity of organic solvent is low enough that volume percent and weight percent are not materially different, so the concentrations previously described can also apply to volume percent.

In one embodiment, the aqueous coating composition comprises:
1. From 76 to 86 pigment volume concentration of inorganic filler;
2. From 5 to 12 weight percent acrylic polymer binder;
3. From 0.3 to 1 weight percent of an alkali metal siliconate;
4. From 0.5 to 5 weight percent other additives; and
5. From 5 to 20 weight percent water,
   wherein the weight percentages are based on the weight of all ingredients including water.

### Use of Aqueous Coating Composition and Resulting Coatings

Among other uses, the aqueous coating composition can be used to make an exterior coating on a substrate, and particularly to make the finish coat in an EIFS exterior. First, the aqueous composition is applied directly or indirectly to a substrate. Second, the aqueous composition is allowed to set (dry and harden). Each of these steps is well-known.

In some embodiments, the substrate is a vertical surface, such as a wall or more particularly an exterior wall of a structure. Examples of appropriate substrates for a wall include any known building surface material, such as wood, plaster, concrete, or synthetic plank. In a particular embodiment, the substrate comprises the insulation layer and the base coat of an EIFS, and the aqueous coating composition is used to form the finish coat of the EIFS.

The composition can be applied by known means. For example, depending on viscosity, it may be applied and spread with a trowel or may be brushed or rolled. If the aqueous coating composition is applied with a trowel, it may also be smoothed or textured, and designs may be added. It is known that some weather conditions, such as rain or extreme cold or humidity, may be inappropriate for applying the aqueous coating composition and may be avoided.

In some embodiments, the aqueous coating composition is applied with an average thickness of at least 0.05 cm or at least 0.1 cm or at least 0.15 cm or at least 0.2 cm or at least 0.5 cm. In some embodiments, the aqueous coating composition is applied with an average thickness of at most 5 cm or at most 3 cm or at most 2.5 cm or at most 2 cm or at most 1.5 cm.

After it is applied, the aqueous coating composition is permitted to set (dry and harden). The time needed for the aqueous coating composition to set may vary widely depending on the water content of the aqueous coating composition and ambient conditions such as temperature and humidity. In some embodiments, the aqueous coating composition dries to the touch after it is applied in no more than 12 hours or no more than 6 hours or no more than 4 hours or no more than 2 hours or no more than 1 hour. In some embodiments, the aqueous coating composition dries to the touch in at least 5 minutes, or at least 10 minutes or at least 15 minutes or at least 20 minutes or at least 30 minutes.

After setting is complete, the aqueous coating composition produces a set coating attached directly or indirectly to the selected substrate. In an EIFS, the set coating may be the finish layer on an EIFS that contains an insulation layer and a base coat as previously described.

The set coating has contents derived from the solid contents of the aqueous coating composition. For example, the set coating may contain:
1. from 70 to 90 PVC of filler, as previously described;
2. acrylic polymer binder in a quantity suitable to adhere the filler to the substrate;
3. alkali metal siliconate and/or its reaction product, in a concentration that is effective to increase the dirt pickup resistance or the color retention of the resulting coating; and

4. from 0 to 8 weight percent other additives, based on the total weight of dry ingredients.

The quantities and descriptions of these ingredients in the set coating are similar to the descriptions for the aqueous coating composition, excluding water. The set coating typically contains less than 2 weight percent water or less than 1 weight percent or less than 0.5 weight percent.

As previously described, the alkali metal siliconate may have reacted in whole or in part to form reaction products, such as silicones.

In some embodiments, the set coating has a dirt pickup resistance that is at least 50 percent, when measured according to the Test Methods, or at least 60 percent or at least 65 percent or at least 70 percent or at least 75 percent or at least 80 percent or at least 85 percent or at least 90 percent. There is no maximum desired dirt pickup resistance, but in some cases resistance greater than 98 percent or 85 percent may be unnecessary.

In some embodiments, the set coating has a dirt pickup resistance that is at least 20 percent greater than a similar set coating without the alkali metal siliconate, when measured according to the Test Methods, or at least 30 percent greater or at least 50 percent greater or at least 75 percent greater or at least 90 percent greater or at least 100 percent greater. There is no maximum desired improvement in dirt pickup resistance, but in some cases improvement greater than 300 percent or 200 percent may be unnecessary.

In some embodiments when color change is measured according to the Test Methods, the set coating has a color change (ΔE) after 5000 hours that is no more than 18, or no more than 15 or no more than 12 or no more than 10 or no more than 8 or no more than 6. There is no minimum desired color change, but in some cases color change less than 2 or 4 may be unnecessary.

In some embodiments when color change is measured according to the Test Methods, the set coating has a color change (ΔE) that is at least 1 percent less than the color change (ΔE) of a similar set coating without the alkali metal siliconate, or at least 2 percent less or at least 4 percent less or at least 6 percent less or at least 8 percent less or at least 10 percent less. There is no maximum desired improvement in color loss, but in some cases improvement greater than 20 percent or 15 percent may be unnecessary. in color loss, but in some cases improvement greater than 20 percent or 15 percent may be unnecessary.

### Test Methods

Parameters described in this application can be measured using the following measurements:

| Parameter | Test |
|---|---|
| Melting/Glass | ASTM E1356-08(2014) Assignment of the |
| Transition | Glass Transition Temperatures by |
| Temperature | Differential Scanning Calorimetry |
| Particle Size (Filler) | ASTM E3340 Laser Diffraction Particle |
| | Size Analysis |
| Emulsion Particle | Measured using laser diffraction with a Beckman |
| Size | Coulter LS13320XR particle size analyzer |
| Viscosity (Paste | Measured with a Krebs Stormer Model KU-1 |
| Units) | using a paste paddle |
| Pigment Volume | See below |
| Concentration | |
| Dirt Pickup Resistance | See below |
| Color Retention | See below |

Pigment Volume Concentration: Pigment volume concentration (PVC) is calculated by the formula:

$$PVC = \frac{{V}_{\text{?}} \text{?} {V}_{\text{?}}}{{V}_{\text{?}} \text{?} {V}_{\text{?}} \text{?} {V}_{\text{?}}} \times 100$$

$$\text{?} \text{indicates text missing or illegible when filed}$$

Wherein Vₚ is the volume of pigment, Vₑ is the volume of filler and V_{b} dry is the dry volume of binder.

Dirt Pickup Resistance: The following materials and equipment are used

| Tools and/or Equipment | Use (if explanation is needed) |
|---|---|
| Aluminum panels (Alodine 1200 S | Test panel |
| treated, 4″ × 12″ panels) | |
| Drawdown bar/Trowel | Apply paint/finish to test substrate |
| 1/16″ thick × ½″ wide tape (3M) | Guide for troweling finish |
| 1″ brush | Apply iron oxide slurry |
| Nylon scrub brush | Removal of iron oxide slurry |
| Davis Colors 641 Brown Iron Oxide | Iron oxide slurry |
| (or equivalent) | |
| Lab mixer | |
| CTR 72° F., @ 50% R.H. | Test panel drying |
| QUV Accelerated Weathering Tester | Test panel drying |
| (The Q Panel Company), UV-A 351 | |
| bulb, no condensation cycle | |
| Gardner Colorgard II 45°/0° | Color measurements |
| Reflectometer (or other suitable color | |
| measuring device). | |

| Step | Sample Preparation |
|---|---|
| 1 | For EIFS finishes: Using the tape as a thickness guide, trowel |
| | each EIFS test finish onto an aluminum panel at a thickness |
| | of 1/16″. Cure each sample at 23° C. and 50% |
| | RH +/− 10% for three days. |
| 2 | After curing, place the coated 4″ × 12″ panels into |
| | a QUV ‘A’ cabinet (100% light, no condensation), with |
| | the test areas facing inward, and expose for 24 hours. |
| 3 | Remove the samples from the QUV and allow them to equilibrate |
| | at 23° C. and 50% RH +/− 10% for 2 hours. Measure initial |
| | sample reflectance with the reflectometer (or other suitable color |
| | instrument), taking the average of three readings. |
| 4 | Formulate an iron oxide slurry by dissolving two drops of |
| | Tamol 731 in 250 grams of water, and then adding 125 grams |
| | of Davis Colors 641 brown iron oxide (or equivalent) under |
| | agitation. Disperse with a laboratory mixer until smooth. |
| 5 | Brush the slurry onto one half of each test sample. Air dry the |
| | slurry coated panels for at least 2 hours, or until the slurry |
| | is visually dry. |
| 6 | Wash each panel under running tepid water while rubbing lightly |
| | and evenly. Rub with a small amount of soap and a nylon scrub |
| | brush. Make sure that all excess iron oxide is removed. Maintain |
| | an even rubbing pressure for each sample. |

| Step | Measuring Dirt Pickup Resistance |
|---|---|
| 1 | Air-dry the samples for at least 24 hours at 23º C. and 50% |
| | RH +/− 10%, and measure the final (dirty) sample Y reflectance, |
| | taking the average of three readings. |
| 2 | Calculate the % Reflectance Retained as: |
| | $\% Reflectance Retained = \frac{Final ( Dirty ) Reflectance}{Initial ( Clean ) Reflectance} \times 100$ |
| 3 | Report the % Reflectance Retained (higher readings indicate |
| | better dirt pickup resistance). |

### Color Retention:

Colortrend 888-7214 blue dye colorant is added at 2% by weight to each finish. The sample is applied to a substrate and cured as described for dirt pickup resistance in Step 1.

The cured samples are weather tested in an Atlas Ci5000 model Weather-o-meter in accordance with ASTM G-155b, using a cycle of 102 minutes dry/18 minutes wet, 100% light, and 0.35 W/m² irradiance. Color is measured before weathering, and after 3000 and 5000 hours exposure, according to ASTM 2244. Color change values, represented by ΔE, are calculated according to changes in the CIE L*a*b* color scale units, according to the equation:

$$Δ E = {[ {( {L}_{measured}^{*} - {L}_{initial}^{*} )}^{2} + {( {a}_{measured}^{*} - {a}_{initial}^{*} )}^{2} + {( {b}_{measured}^{*} - {b}_{initial}^{*} )}^{2} ]}^{0.5}$$

### Examples

The following examples illustrate some embodiments of the invention, but do not limit the full scope of the invention.

Eight finish coat compositions are prepared containing the components listed in Tables 1 through 3. The PVC for each formula is listed in the Tables.

TABLE 1

| | Finish 1 | | | Finish 2 | | |
|---|---|---|---|---|---|---|
| | | Wt | | | Wt | |
| Component | Tradename | (gm) | Wt % | Tradename | (gm) | Wt % |
| Filler/Pigment | | | | | | |
| Predispersed | Ti-Pure R-746 | 64.9 | 4.07% | Ti-Pure R-746 | 45.6 | 3.06% |
| TiO₂ | (76%) | | | (76%) | | |
| Sand | Unimin 50-30 | 850.0 | 53.29% | Unimin 50-30 | 780.3 | 52.42% |
| Sand | Temisca #15 | 142.3 | 8.92% | Temisca #15 | 191.5 | 12.86% |
| K—Al silicate | Minex 4 | 137.0 | 8.59% | — | — | — |
| CaCO₃ | — | — | — | Omyacarb 40 | 79.8 | 5.36% |
| CaCO₃ | — | — | — | Omyacarb 2 | 95.7 | 6.43% |
| Organic | RHOPLEX ™ EI- | 287.8 | 18.05% | PRIMAL ™ | 235.1 | 15.79% |
| Binder | 2000 (46.5%) | | | WDV-2001 | | |
| | | | | (46.5%) | | |
| Additives | | | | | | |
| Open Time | Ethylene Glycol | 5.0 | 0.31% | — | — | — |
| Additive | | | | | | |
| Thickener | ACRYSOL ™ | 7.5 | 0.47% | METHOCEL ™ | 1.6 | 0.11% |
| | ASE-60 | | | J75MS | | |
| Biocide | Rozone 2000 | 2.0 | 0.13% | Rozone 2000 | 1.6 | 0.11% |
| Dispersant | — | — | — | Calgon N (10%) | 16.0 | 1.07% |
| Dispersant | | | | TAMOL ™ 165A | 3.0 | 0.20% |
| Defoamer | Nopco NXZ | 2.0 | 0.13% | Nopco NXZ | 1.6 | 0.11% |
| Rheology | Attagel 50 | 10.0 | 0.63% | — | — | — |
| Additive | | | | | | |
| Coalescent | Texanol | 4.0 | 0.25% | DOWANOL ™ | 5.5 | 0.37% |
| | | | | DPnB | | |
| pH Adjustment | Ammonia (28%) | 2.5 | 0.16% | NaOH (10%) | 3.2 | 0.22% |
| Water | | 79.8 | 5.00% | | 28.2 | 1.89% |
| Totals | | 1594.8 | 100.0% | Totals | 1488.7 | 100.0% |
| PVC: | | 79 | | | 82 | |

TABLE 2

| | | Fin- | Fin- | Fin- |
|---|---|---|---|---|
| Ingredient | Type | ish 3 | ish 4 | ish 5 |
| Filler/Pigment | | | | |
| Ti-Pure R-746 | Titanium Dioxide | 45.60 | 45.60 | 45.60 |
| Temisca #15 sand | Sand | 191.50 | 191.50 | 191.50 |
| Unimin 50-30 sand | Sand | 780.30 | 780.30 | 780.30 |
| Minex 4 | Filler | 156.69 | 156.69 | 156.69 |
| Binder | | | | |
| RHOPLEX ™ | Acrylic binder | 282.20 | 235.50 | 189.30 |
| EI-2000 | solution ~46.5% | | | |
| | solids | | | |
| Additives | | | | |
| Ethylene Glycol | Solvent | 5.00 | 5.00 | 5.00 |
| Nopco NXZ | Defoamer | 2.00 | 2.00 | 2.00 |
| Attagel 50 | Clay Thickener | 9.88 | 9.88 | 9.88 |
| Rozone 2000 | Preservative | 2.00 | 2.00 | 2.00 |
| Texanol | Coalescent | 6.56 | 5.48 | 4.40 |
| Ammonia (28%) | Neutralizing Agent | 2.50 | 2.50 | 2.50 |
| ACRYSOL ™ | Thickener | 7.50 | 7.50 | 7.50 |
| ASE-60 Water | | 81.45 | 97.45 | 107.45 |
| | Totals | 1573.18 | 1541.40 | 1504.12 |

| Property | Approximate Values | | |
|---|---|---|---|
| Volume Solids | 67.3 | 68.8 | 70.4 |
| Weight Solids | 82.9 | 84.1 | 85.3 |
| Density (lb/gal) | 16.0 | 16.4 | 16.9 |
| PVC | 79 | 82 | 85 |

TABLE 3

| | | Fin- | Fin- | Fin- |
|---|---|---|---|---|
| Ingredient | Type | ish 6 | ish 7 | ish 8 |
| Filler/Pigment | | | | |
| Ti-Pure R-746 | Titanium Dioxide | 45.60 | 45.60 | 45.60 |
| Unimin 50-30 sand | Sand | 780.30 | 780.30 | 780.30 |
| Temisca #15 sand | Sand | 191.50 | 191.50 | 191.50 |
| Omyacarb 2 | Extender | 95.70 | 95.70 | 95.70 |
| Omyacarb 40 | Extender | 79.80 | 79.80 | 79.80 |
| Binder | | | | |
| PRIMAL ™ WDV- | Acrylic binder | 285.70 | 236.00 | 189.70 |
| 2001 | solution ~46% | | | |
| | solids | | | |
| Additives | | | | |
| METHOCEL ™ | Thickener | 1.60 | 1.60 | 1.60 |
| J75MS | | | | |
| Rozone 2000 | Preservative | 1.60 | 1.60 | 1.60 |
| Calgon N (10%) | Dispersant | 16.00 | 16.00 | 16.00 |
| Water | Water | 8.28 | 8.28 | 8.28 |
| TAMOL ™ 165 | Dispersant | 3.00 | 3.00 | 3.00 |
| Nopco NXZ | Defoamer | 1.60 | 1.60 | 1.60 |
| DOWANOL ™ DPnB | Coalescent | 6.64 | 5.49 | 4.41 |
| NaOH (10%) | Neutralizing | 3.20 | 3.20 | 3.20 |
| | Agent | | | |
| Water | Water | 1.46 | 26.56 | 49.91 |
| | Totals | 1521.98 | 1496.23 | 1472.20 |

| Property | Approximate Values | | |
|---|---|---|---|
| Volume Solids | 74.7 | 74.3 | 73.9 |
| Weight Solids | 87.4 | 87.4 | 87.3 |
| Density (lb/gal) | 16.8 | 17.1 | 17.3 |
| PVC | 79 | 82 | 85 |

### Dirt Pickup Resistance (DPUR) Testing

Finish 1 and Finish 2 are blended with aqueous potassium methyl siliconate solution (XIAMETER™ OFS-0777, 40-45% solids) in the proportions set out in Table 4, to make Inventive Examples 1-6. Finish 1 and Finish 2 are also blended with the following other additives in the proportions set out in Table 4, to make Comparative Examples 1-8.
DOWSIL™ Z70 silicone polymer emulsion (60% solids)·
DOWSIL™ Q1-3563 silicone fluid
SP 1: a stabilizer package containing 2 parts Tinuvin 1130 hydroxyphenyl benzotriazole UV absorber and 1 part Tinuvin 292 hindered amine stabilizer.
   For clarity in Examples IE1, IE2 and CE2-CE4, the DPUR additive (potassium methyl siliconate solution or alternative additive) is added to the completely formulated Finish 1 or Finish 2. In Examples IE3-IE6 and CE6-CE8, the DPUR additive is added to the binder before it is mixed with other ingredients to form the Finish 1 or Finish 2.

The sample finishes are applied to panels and tested for dirt pickup resistance as set out in the Test Methods. Results are listed in Table 4.

TABLE 4

| | | | Additive | |
|---|---|---|---|---|
| Example | Finish | DPUR Additive | Wt. %² | DPUR¹ |
| IE1 | 1 | XIAMETER ™ OFS-0777 | 1 | 47 |
| IE2 | 2 | XIAMETER ™ OFS-0777 | 1 | 94 |
| IE3 | 2 | XIAMETER ™ OFS-0777 | 0.5 | 47 |
| IE4 | 2 | XIAMETER ™ OFS-0777 | 1.0 | 68 |
| IE5 | 2 | XIAMETER ™ OFS-0777 | 1.5 | 89 |
| IE6 | 2 | XIAMETER ™ OFS-0777 | 2.0 | 96 |
| CE1 | 1 | None | 0 | 28 |
| CE2 | 1 | DOWSIL ™ Z70 | 1.5 | 29 |
| CE3 | 1 | DOWSIL ™ Q1-3563 | 2 | 26 |
| CE4 | 1 | SP1 | 0.25 | 32 |
| CE5 | 2 | None | 0 | 32 |
| CE6 | 2 | DOWSIL ™ Z70 | 1.5 | 40 |
| CE7 | 2 | DOWSIL ™ Q1-3563 | 2 | 35 |
| CE8 | 2 | SP1 | 0.25 | 32 |

¹% Y Reflectance retained. Higher number is less dirt retained and better DPUR.
²XIAMETER ™ OFS-0777 contains about 40 weight percent solids in water. The measured quantity refers to the solution, not the solids.

### Color Retention

Finish 1 and Finish 2 are blended with XIAMETER™ OFS-0777 aqueous potassium methyl siliconate solution (40-45% solids) in the proportions set out in Table 5, to make Inventive Examples 7-8. Finish 1 and Finish 2 are also blended with the other additives previously listed, in the proportions set out in Table 5, to make Comparative Examples 9-16. Colortrend 888-7214 blue dye colorant is added at 2% by weight to each finish. The finishes are applied to panels and tested for color loss as set out in the Test Methods, i.e., test color after drying, followed by accelerated photoaging for 5045 hours, followed by measurement of color again. The results are listed in Table 5.

TABLE 5

| | | | Additive | Color |
|---|---|---|---|---|
| Example | Finish | DPUR Additive | Wt. % | Loss² |
| IE7 | 1 | XIAMETER ™ OFS-0777 | 1 | 6.7 |
| IE8 | 2 | XIAMETER ™ OFS-0777 | 1 | 15.6 |
| CE9 | 1 | None | 0 | 9.9 |
| CE10 | 1 | DOWSIL ™ Z70 | 1.5 | 7.2 |
| CE11 | 1 | DOWSIL ™ Q1-3563 | 2 | 9 |
| CE12 | 1 | SP1 | 0.25 | 5.7 |
| CE13 | 2 | None | 0 | 21.2 |
| CE14 | 2 | DOWSIL ™ Z70 | 1.5 | 7.7 |
| CE15 | 2 | DOWSIL ™ Q1-3563 | 2 | 8.1 |
| CE16 | 2 | SP1 | 0.25 | 15.7 |

²ΔE. Lower number is less color loss, and better tint retention.

The tint retention test is repeated with Finishes 3-8, using 3000 hour and 5000 hour photo aging. The results are listed in Table 6.

TABLE 6

| | | | Addi- | 3000 hr | 5000 hr |
|---|---|---|---|---|---|
| Exam- | Fin- | | tive | Color | Color |
| ple | ish | DPUR Additive | Wt. % | Loss | Loss |
| IE9 | 3 | XIAMETER ™ OFS-0777 | 1 | 1.9 | 6.4 |
| IE10 | 4 | XIAMETER ™ OFS-0777 | 1 | 2.7 | 8.8 |
| IE11 | 5 | XIAMETER ™ OFS-0777 | 1 | 5.0 | 14.4 |
| IE12 | 6 | XIAMETER ™ OFS-0777 | 1 | 1.8 | 4.8 |
| IE13 | 7 | XIAMETER ™ OFS-0777 | 1 | 1.7 | 7.6 |
| IE14 | 8 | XIAMETER ™ OFS-0777 | 1 | 2.9 | 10.1 |
| CE17 | 3 | None | 0 | 4.5 | 12.8 |
| CE18 | 3 | DOWSIL ™ Z70 | 1.5 | 4.5 | 9.3 |
| CE19 | 3 | DOWSIL ™ Q1-3563 | 2 | 4.8 | 10.1 |
| CE20 | 3 | SP1 | 0.25 | 2.3 | 7.6 |
| CE21 | 4 | None | 0 | 7.2 | 20.5 |
| CE22 | 4 | DOWSIL ™ Z70 | 1.5 | 7.0 | 14.6 |
| CE23 | 4 | DOWSIL ™ Q1-3563 | 2 | 7.1 | 14.5 |
| CE24 | 4 | SP1 | 0.25 | 4.3 | 13.9 |
| CE25 | 5 | None | 0 | 14.5 | 29.6 |
| CE26 | 5 | DOWSIL ™ Z70 | 1.5 | 11.8 | 23.2 |
| CE27 | 5 | DOWSIL ™ Q1-3563 | 2 | 13.0 | 24.2 |
| CE28 | 5 | SP1 | 0.25 | 8.8 | 23.7 |
| CE29 | 6 | None | 0 | 3.2 | 10.1 |
| CE30 | 6 | DOWSIL ™ Z70 | 1.5 | 2.9 | 4.7 |
| CE31 | 6 | DOWSIL ™ Q1-3563 | 2 | 3.0 | 4.8 |
| CE32 | 6 | SP1 | 0.25 | 2.6 | 8.4 |
| CE33 | 7 | None | 0 | 6.8 | 13.0 |
| CE34 | 7 | DOWSIL ™ Z70 | 1.5 | 3.3 | 6.1 |
| CE35 | 7 | DOWSIL ™ Q1-3563 | 2 | 3.2 | 5.9 |
| CE36 | 7 | SP1 | 0.25 | 4.3 | 11.7 |
| CE37 | 8 | None | 0 | 5.6 | 14.0 |
| CE38 | 8 | DOWSIL ™ Z70 | 1.5 | 4.5 | 8.5 |
| CE39 | 8 | DOWSIL ™ Q1-3563 | 2 | 4.1 | 8.1 |
| CE40 | 8 | SP1 | 0.25 | 4.3 | 11.1 |

Formulations with High TiO₂ and Benzophenone

Finish 2 is repeated, except the Finish contains 6 weight percent TiO₂, and 0.3 weight percent benzophenone is added. Samples of the finish are blended with the additional dirt pickup (DPUR) additives shown in Table 7. The samples are applied to panels and tested for Dirt Pickup Resistance according to the Test Methods. The results are shown in Table 7. Examples named IE are inventive examples, and examples named CE are comparative examples.

TABLE 7

| Ex. No. | DPUR Additive | DPUR¹ |
|---|---|---|
| IE 15 | 1% XIAMETER ™ OFS-0777 siliconate solution | 66 |
| IE 16 | 1% XIAMETER ™ OFS-0772 siliconate solution | 57 |
| CE 41 | None | 47 |
| CE 42 | 1% DOWSIL ™ Z-70 silicone emulsion | 44 |
| CE 43 | 1% DOWSIL ™ Q1-3563 silicone fluid | 36 |

¹% Y Reflectance retained. Higher number is less dirt retained and better DPUR.

Formulations with High TiO₂ and Styrene Acrylic Binder

Finish 2 is repeated, except the Finish contains 6 weight percent TiO₂, and UCAR™ DL 424, a styrene acrylic binder, is substituted for the PRIMAL™ WDV-2001 binder. Samples of the finish are blended with the additional DPUR additives shown in Table 8. The samples are applied to panels and tested for Dirt Pickup Resistance according to the Test Methods. The results are shown in Table 8. Examples named IE are inventive examples, and examples named CE are comparative examples.

TABLE 8

| Ex. No. | DPUR Additive | DPUR¹ |
|---|---|---|
| IE 17 | 1% XIAMETER ™ OFS-0777 siliconate solution | 48 |
| IE 18 | 1% XIAMETER ™ OFS-0772 siliconate solution | 42 |
| CE 44 | None | 36 |
| CE 45 | 1% DOWSIL ™ Z-70 silicone emulsion | 35 |

¹% Y Reflectance retained. Higher number is less dirt retained and better DPUR.

Formulations with High TiO₂, Cross-linking Binder, and Benzophenone

Finish 2 is repeated, except the Finish contains 6 weight percent TiO₂, RHOPLEX™ VSR-1065, a cross-linking acrylic binder, is substituted for the PRIMAL™ WDV-2001 binder, and 0.3 weight percent benzophenone is added. Samples of the finish are blended with the additional DPUR additives shown in Table 9. The samples are applied to panels and tested for Dirt Pickup Resistance according to the Test Methods. The results are shown in Table 9. Examples named IE are inventive examples, and examples named CE are comparative examples.

TABLE 9

| Ex. No. | DPUR Additive | DPUR¹ |
|---|---|---|
| IE 19 | 1% XIAMETER ™ OFS-0777 siliconate solution | 97 |
| CE 46 | None | 59 |
| CE 47 | 1% DOWSIL ™ Q1-3563 silicone fluid | 35 |

¹% Y Reflectance retained. Higher number is less dirt retained and better DPUR.

Formulations with Alternate Dirt Pickup Resistance Additives

Samples prepared with Finish 2 are blended with the DPUR additives shown in Table 10. The samples are applied to panels and tested for Dirt Pickup Resistance according to the Test Methods. The results are shown in Table 10. Examples named IE are inventive examples, and examples named CE are comparative examples.

TABLE 10

| Ex. No. | DPUR Additive | DPUR¹ |
|---|---|---|
| CE 48 | None | 24 |
| CE 49 | 0.3% benzophenone | 31 |
| CE 50 | 0.4% methyl2-benzoyl benzoate | 27 |
| IE 20 | 1% XIAMETER ™ OFS-0777 siliconate solution | 69 |
| IE 21 | 0.3% benzophenone + 1% XIAMETER ™ | 89 |
| | OFS-0777 siliconate solution | |
| IE-22 | 0.4% methyl2-benzoyl benzoate + 1% | 83 |
| | XIAMETER ™ OFS-0777 siliconate solution | |
| CE 51 | 1% DOWSIL ™ Z-70 silicone emulsion | 25 |
| CE 52 | 0.3% benzophenone + 1% DOWSIL ™ Z-70 | 31 |
| | silicone emulsion | |
| CE 53 | 0.4% methyl2-benzoyl benzoate + 1% DOWSIL ™ | 29 |
| | Z-70 silicone emulsion | |

¹% Y Reflectance retained. Higher number is less dirt retained and better DPUR. Measurement is for the light-exposed portion of the panel.

1. An aqueous coating composition comprising:
a) From 70 to 90 pigment volume concentration of inorganic filler; and
b) An acrylic polymer binder in a concentration effective to bind the filler and other components of the aqueous coating composition to a substrate; and
c) An alkali metal siliconate, in a concentration that is effective to increase the dirt pickup resistance or color retention of the resulting coating; and
d) Water in a quantity sufficient to fully wet the dry ingredients and provide a slurry.

2. The aqueous coating composition of claim 1 wherein the pigment volume concentration of inorganic filler is at least 75, the concentration of acrylic polymer binder is from 5 weight percent to 18 weight percent, and the concentration of alkali metal siliconate is from 0.2 to 3.5 weight percent, wherein weight percentages are based on the total weight of dry ingredients excluding water and the “dry ingredients” are the filler, the acrylic polymer binder, the alkali metal siliconate and any other solid additives to the aqueous coating composition.

3. The aqueous coating composition of claim 2 wherein the pigment volume concentration of inorganic filler is from 78 to 86.

4. The aqueous coating composition of claim 2 wherein the quantity of alkali metal siliconate is from 0.3 to 2 weight percent, based on the total weight of dry ingredients excluding water.

5. The aqueous coating composition of claim 2 wherein the alkali metal siliconate comprises sodium methyl siliconate or potassium methyl siliconate.

6. The aqueous coating composition of claim 2 which has a viscosity from 70 PU to 140 PU.

7. The aqueous coating composition of claim 2 wherein the quantity of water is from 5 to 20 weight percent of the entire aqueous coating composition.

8. The aqueous coating composition of claim 2 which further contains from 0.2 to 8 weight percent of other additives aside from components (a), (b), (c) and (d), which additives are selected from the group consisting of organic dyes and pigments, thickeners, surfactants, hydrophobic additives, levelling and coalescing agents, antioxidants, light and ultraviolet light stabilizers, and additional dirt pickup resistance additives other than the alkali metal siliconate, wherein weight percentages are based on the total weight of dry ingredients excluding water.

9. The aqueous coating composition of claim 8 wherein the other additives include an additional dirt pickup reducing additive other than the alkali metal siliconate.

10. The aqueous coating composition of claim 2 wherein the acrylic polymer binder contains repeating units derived from a crosslinking monomer.

11. The aqueous coating composition of claim 1 which comprises:
a) From 76 to 86 pigment volume concentration of inorganic filler;
b) From 5 to 12 weight percent acrylic polymer binder;
c) From 0.3 to 1 weight percent of an alkali metal siliconate;
d) From 0.5 to 5 weight percent other additives; and
e) From 5 to 20 weight percent water,
wherein all weight percentages are based on the weight of all ingredients including water.

12. An exterior insulation and finish system, called EIFS, attached to an exterior surface of a structure, which EIFS comprises:
a) A layer of insulation that comprises a foamed polymer insulation and is adhered directly or indirectly to a substrate that forms the exterior surface of the structure;
b) A base coat that comprises a fiber mesh embedded in a coating material and is adhered directly or indirectly to the insulation layer; and
c) A finish coat that is adhered directly or indirectly to the base coat and comprises:
i) From 70 to 90 pigment volume concentration of inorganic filler and/or inorganic pigment;
ii) An acrylic polymer binder in a concentration effective to bind the filler and other components of the finish coat to a substrate; and
iii) An alkali metal siliconate and/or its reaction products in a concentration that is effective to increase the dirt pickup resistance or color retention of the finish coat.

13. The exterior insulation and finish and insulation system of claim 12 wherein the finish coat contains:
a) From 76 to 86 pigment volume concentration of inorganic filler and/or inorganic pigment;
b) From 6 to 15 weight percent acrylic polymer binder;
c) From 0.3 to 1 weight percent of an alkali metal siliconate;
d) From 0.2 to 8 weight percent other additives; and
e) less than 2 weight percent water,
wherein all weight percentages are based on the weight of ingredients (a)-(d).

14. The exterior insulation and finish system of claim 12 wherein the finish coat has a dirt pickup resistance of at least 50 percent when tested according to the Test Methods.

15. The exterior insulation and finish system of claim 12 wherein the finish coat has a color change (ΔE) of no more than 12 after 5000 hours when tested according to the Test Methods.
